(19) United States
(12) Patent Application Publication
(10) Pub. No.: US 2024/0215120 A1
(43) Pub. Date: Jun. 27, 2024

(54) FILM HEATER AND HEATER-EQUIPPED GLASS

(71) Applicant: TDK CORPORATION, Tokyo (JP)

(72) Inventors: Shouhei HARADA, Tokyo (JP); Koji MISHIMA, Tokyo (JP); Kazushi YAMADA, Tokyo (JP); Kazuhisa INABA, Tokyo (JP); Hideaki ITOU, Tokyo (JP)

(73) Assignee: TDK CORPORATION, Tokyo (JP)

(21) Appl. No.: 18/288,247

(22) PCT Filed: Apr. 25, 2022
(86) PCT No.: PCT/JP2022/018733

§ 371 Date: Oct. 25, 2023

(30) Foreign Application Priority Data
Apr. 26, 2021 (JP) 2021-074132

(51) Int. Cl. H05B 3/86; H05B 3/22

(52) U.S. Cl. CPC H05B 3/86; H05B 3/22

(57) ABSTRACT

A film heater includes: a substrate; a first hard coat layer containing a first resin component and a silica filler; a first dielectric layer; a metal layer containing one or both of silver and silver alloy; a second dielectric layer; and an ITO layer or an IZO layer in the order presented, wherein a thickness of the metal layer is 5.5 to 7.5 nm, and wherein a peak intensity indicating a Kα line of silicon element detected by fluorescent X-ray analysis of a surface on the first dielectric layer side of the first hard coat layer is 15 to 35 cps.

### TECHNICAL FIELD

The present disclosure relates to a film heater and a heater-equipped glass.

### BACKGROUND ART

Glass with a heater function is used for glass of vehicles, outdoor display devices, buildings, and the like for preventing fogging, melting snow, preventing dew condensation, and the like. As such glass with a heater function, glass with a heater function in which a nichrome thin wire is disposed in glass is conventionally known. However, in the case of such glass with a heater function, the nichrome thin wire inhibits the transmission visibility. Therefore, it has been studied to use a transparent conductive film for the heater. For example, Patent Document 1 proposes a transparent film heater having a transparent conductive layer containing a conductive polymer and a current-carrying electrode on at least one surface of a transparent substrate.

### CITATION LIST

### Patent Literature

[Patent Document 1] Japanese Unexamined Patent Publication No. 2016-126913

### SUMMARY OF INVENTION

### Technical Problem

Since the film heater may be used outdoors depending on the application, the film heater is required to have excellent durability. Depending on the application, excellent transmission visibility is also required in some cases. Accordingly, the present disclosure provides a film heater that has excellent durability and is capable of sufficiently reducing the absorption rate of visible light. The present disclosure provides a heater-equipped glass including a film heater that is excellent in durability and can sufficiently reduce the absorption rate of visible light.

### Solution to Problem

The present disclosure provides a film substrate including: a substrate; a first hard coat layer containing a first resin component and a silica filler; a first dielectric layer; a metal layer containing one or both of silver and silver alloy; a second dielectric layer; and an ITO layer or an IZO layer in the order presented, in which a thickness of the metal layer is 5.5 to 7.5 nm, and a peak intensity indicating a Kα line of silicon element detected by fluorescent X-ray analysis of a surface on the first dielectric layer side of the first hard coat layer is 15 to 35 cps.

In the film heater, a peak intensity indicating a Kα line of silicon element detected by fluorescent X-ray analysis of the surface on the first dielectric layer side of the first hard coat layer is larger than a predetermined value. The silica filler is sufficiently exposed on the surface of the first dielectric layer side of the first hard coat layer. Since the silica filler is exposed in this manner, the adhesion between the first hard coat layer and the first dielectric layer or between a layer that is in contact with the first hard coat layer between the first hard coat layer and the first dielectric layer can be sufficiently enhanced. Therefore, the durability of the film heater can be enhanced.

In the film heater, a peak intensity indicating a Kα line of silicon element detected by fluorescent X-ray analysis of a surface on the second dielectric layer side of the first hard coat layer is smaller than a predetermined value. Accordingly, the surface of the first hard coat layer is prevented from being excessively uneven, and the content of the silica filler is prevented from being excessively high. Further, the thickness of the metal layer is within a predetermined range. By these factors, the absorption rate of visible light can be sufficiently reduced. Such a film heater may have high transparency.

The film heater may further include: a second hard coat layer containing a second resin component; and a low reflective layer in the presented order from the substrate side on a side opposite to the first hard coat layer side of the substrate, and the low reflective layer may have a refractive index smaller than that of the substrate and that of the second hard coat layer and greater than that of air. Accordingly, it is possible to reduce the reflectivity when the visible light incident from the surface on the ITO layer side or the IZO layer side of the film heater is emitted from the surface on the opposite side of the film heater, and to sufficiently increase the transmissivity of the visible light. Therefore, the transparency of the film heater can be further enhanced.

The film heater may further include a high refractive index layer between the first hard coat layer and the first dielectric layer. Accordingly, the transmissivity of visible light incident from the second dielectric layer side of the film heater can be sufficiently enhanced.

A content of the silica filler with respect to the first resin component of the first hard coat layer may be 8 to 20% by mass. This makes it possible to further increase the adhesion between the first hard coat layer and the layer in contact with the first hard coat layer, and further reduce the absorption rate of visible light.

The present disclosure provides a heater-equipped glass including any one of the film heaters described above, an electrode on a surface of the ITO layer or the IZO layer, and a glass plate facing the ITO layer or the IZO layer and the electrode.

The heater-equipped glass includes any one of the film heaters described above. Accordingly, the absorption rate of visible light is sufficiently low, and durability is excellent. Such a heater-equipped glass can be suitably used for applications where high durability and transparency are required. For example, it is suitably used for vehicles, outdoor display devices, and buildings. However, the use of the heater-equipped glass is not limited to those described above.

### Advantageous Effects of Invention

A film heater which is excellent in durability and can sufficiently reduce an absorption rate of visible light can be provided. A heater-equipped glass provided with a film heater excellent in durability and capable of sufficiently reducing the absorptivity of visible light can be provided.

### BRIEF DESCRIPTION OF DRAWINGS

FIG. 1 is a schematic cross-sectional view illustrating an example of a film heater.

FIG. 2 is a schematic cross-sectional view illustrating another example of a film heater.

FIG. 3 is a schematic cross-sectional view illustrating an example of a heater-equipped glass.

### DESCRIPTION OF EMBODIMENTS

Hereinafter, embodiments of the present disclosure will be described with reference to the accompanying drawings. However, the following examples are illustrative for describing the present disclosure and are not intended to limit the present disclosure to the following contents. In the following description, elements having the same structure or the same function are denoted by the same reference numerals, and redundant description thereof will be omitted. Positional relationships such as up, down, left, and right are based on positional relationships illustrated in the drawings unless otherwise specified. The dimensional ratio of each element is not limited to the illustrated ratio.

A film heater includes: a substrate; a first hard coat layer containing a first resin component and a silica filler; a first dielectric layer; a metal layer containing one or both of silver and silver alloy; a second dielectric layer; and an ITO layer or an IZO layer in the order presented. The film heater may be transparent (a transparent film heater).

In the present disclosure, “ITO” refers to Indium Tin Oxide. In the present disclosure, “IZO” refers to indium zinc oxide. In the present disclosure, “transparent” means that visible light is transmitted, and light may be scattered to some extent. The concept of “transparent” in the present disclosure also includes products that scatter light and are generally referred to as translucent. For example, a film heater having a transmissivity of 75% or more in a wave length range of 360 to 740 nm corresponds to a transparent film heater. The above-described transmissivity of the transparent film heater may be 80% or more. Visible light in the present disclosure refers to light in a range of wavelengths from 360 to 740 nm.

The substrate in the film heater is a transparent substrate, and may be, for example, an organic substrate formed of an organic resin film having flexibility. The organic resin film may be an organic resin sheet. Examples of the organic resin film include polyester films such as polyethylene terephthalate (PET) films and polyethylene naphthalate (PEN) films; polyolefin films such as polyethylene films and polypropylene films; polycarbonate films; acrylic films; norbornene films; polyarylate films; polyether sulfone films; diacetylcellulose films; and triacetyl cellulose films. Among these, polyester films such as polyethylene terephthalate (PET) films and polyethylene naphthalate (PEN) films are preferable. One of those mentioned above may be used singly or two or more of them may be used in combination. However, the substrate is not limited to those made of organic resins, and may be, for example, moldings of inorganic compounds such as soda-lime glass, alkali-free glass, and quartz glass.

The substrate of the film heater is preferably thick from the viewpoint of rigidity. On the other hand, the substrate is preferably thin from the viewpoint of making the film heater thin. From such a viewpoint, the thickness of the substrate is, for example, 10 to 200 μm. The first hard coat layer contains, for example, a resin component obtained by curing a resin composition (first resin component); and a silica filler dispersed in the resin component. It is preferable that the resin composition contains at least one selected from thermosetting resin compositions, ultraviolet-curable resin compositions, and electron beam-curable resin compositions. As a thermosetting resin composition, at least one selected from epoxy resins, phenoxy resins, and melamine resins may be contained.

The resin composition is, for example, a composition containing a curable compound having an energy ray-reactive group such as a (meth)acryloyl group and a vinyl group. The expression “(meth)acryloyl group” is intended to include at least one of an acryloyl group and a methacryloyl group. It is preferable that the curable compound contains a polyfunctional monomer or oligomer having two or more, preferably three or more energy ray-reactive groups in one molecule.

The curable compound preferably contains an acrylic monomer. Specific examples of the acrylic monomer include 1,6-hexanediol di(meth)acrylate, triethylene glycol di(meth)acrylate, ethylene oxide-modified bisphenol A di(meth)acrylate, trimethylolpropane tri(meth)acrylate, trimethylolpropane ethylene oxide-modified tri(meth)acrylate, trimethylolpropane propylene oxide-modified tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, pentaerythritol tri(meth)acrylate, and 3-(meth)acryloyloxy glycerin mono(meth)acrylate. However, the acrylic monomer is not necessarily limited thereto. Examples thereof also include urethane-modified acrylates and epoxy-modified acrylates.

As the curable compound, a compound having a vinyl group may be used. Examples of the compound having a vinyl group include ethylene glycol divinyl ether, pentaerythritol divinyl ether, 1,6-hexanediol divinyl ether, trimethylolpropane divinyl ether, ethylene oxide-modified hydroquinone divinyl ether, ethylene oxide-modified bisphenol A divinyl ether, pentaerythritol trivinyl ether, dipentaerythritol hexavinyl ether, and ditrimethylolpropane polyvinyl ether. However, the compound having a vinyl group is not necessarily limited thereto.

When the curable compound is cured with an ultraviolet ray, the resin composition contains a photopolymerization initiator. As the photopolymerization initiator, various photopolymerization initiators can be used. For example, a photopolymerization initiator can be appropriately selected from known compounds including acetophenone-based, benzoin-based, benzophenone-based, and thioxanthone-based compounds. More specific examples thereof include Darocur 1173, Irgacure 651, Irgacure 184, Irgacure 907, and Irgacure 127 (product names, manufactured by Ciba Specialty Chemicals), and KAYACURE DETX-S (product name, manufactured by Nippon Kayaku Co., Ltd.).

The content of the photopolymerization initiator may be 0.01 to 20% by mass and may be 1 to 10% by mass based on the mass of the resin composition. The resin composition may be a known resin composition containing an acrylic monomer and a photopolymerization initiator. Examples of the polymer composition containing an acrylic monomer and a photopolymerization initiator include SD-318 (product name, manufactured by Dainippon Ink and Chemicals, Inc.), which is ultraviolet curable, and XNR5535 (product name, manufactured by NAGASE & CO., LTD.).

When a resin composition curable by energy rays is used, the resin composition can be cured by irradiation with energy rays such as ultraviolet rays.

From the viewpoint of improving the adhesion between the first hard coat layer and the layer adjacent thereto, the average grain size of the silica filler dispersed in the resin components in the first hard coat layer may be 10 nm or more, or may be 20 nm or more. From the viewpoint of ensuring sufficient transparency, the average grain size of the silica filler may be 200 nm or less, or may be 150 nm or less. The average grain size is a grain size (median size, D50) when an integrated value from a small grain size reaches 50% of the whole in a cumulative distribution of a grain size distribution on a number basis measured by using a grain size distribution measuring device by a laser diffraction/scattering method. The silica filler may be treated with a silane coupling agent, and an energy ray reactive group such as a (meth)acryloyl group and/or a vinyl group may be formed in a film shape on the surface of the silica filler.

The content of the silica filler with respect to the resin component in the first hard coat layer may be 8 to 20% by mass. From the viewpoint of sufficiently increasing adhesion between the first hard coat layer and a layer (for example, a high refractive index layer or the first dielectric layer) in direct contact with the first hard coat layer, the lower limit of the content may be 10% by mass, 12% by mass, or 14% by mass. From the viewpoint of sufficiently lowering the absorption rate of visible light of the film heater, the upper limit of the content may be 17% by mass or 15% by mass. When the content of the silica filler is too small, the influence of thermal expansion and swelling of the resin component increases in a high-temperature and high-humidity environment, and durability tends to be impaired. On the other hand, when the content of the silica filler is too large, the absorption rate of visible light tends to increase.

The peak intensity indicating the Kα line of the silicon element detected by fluorescent X-ray analysis of the surface on the first dielectric layer side of the first hard coat layer is 15 to 35 cps. This peak intensity is an index of the amount of silica filler exposed on the surface on the first dielectric layer side of the first hard coat layer. That is, as the intensity increases, the amount of the silica filler exposed to the surface of the first hard coat layer increases. Since the peak intensity is equal to or greater than the lower limit value, it is possible to sufficiently increase adhesion of a layer in contact with the first hard coat layer between the first hard coat layer and the first dielectric layer or between the first hard coat layer and a layer in contact with the first hard coat layer between the first hard coat layer and the first dielectric layer. Therefore, the durability of the film heater can be enhanced.

From the viewpoint of further improving the durability of the film heater, the lower limit value of the peak intensity may be 17 cps, may be 19 cps, or may be 25 cps. On the other hand, from the viewpoint of sufficiently reducing the visible light transmissivity of the film heater, the upper limit value of the peak intensity may be 30 cps or may be 27 cps. The measurement conditions of the fluorescent X-ray analysis are as described in Examples.

The above-described peak intensity may be adjusted by changing the content of the silica filler in the first hard coat layer.

The first hard coat layer can be formed by applying a coating material (dispersion liquid) containing a solvent, a polymer composition, and a silica filler to one surface of the substrate, drying the coating material, and curing the polymer composition. The coating can be carried out by a known method. Examples of the coating method include an extrusion nozzle method, a blade method, a knife method, a bar coat method, a kiss coat method, a kiss reverse method, a gravure roll method, a dip method, a reverse roll method, a direct roll method, a curtain method, and a squeezing method. As the solvent, an ordinary organic solvent can be used. When the viscosity of the above-described coating material is increased, the silica filler is less likely to precipitate downward (substrate side). Thus, the peak intensity can be increased. From such a viewpoint, the viscosity (20° C.) of the coating material is preferably, for example, 0.8 to 1.2 mPa·s.

The thickness of the first hard coat layer may be, for example, 0.1 to 10 μm, or may be 0.5 to 5 μm. Accordingly, adhesion between the first hard coat layer and a layer (for example, the high refractive index layer or the first dielectric layer) in direct contact with the first hard coat layer can be sufficiently increased, and occurrence of thickness unevenness, wrinkles, and the like can be sufficiently suppressed. The refractive index of the first hard coat layer may be, for example, 1.40 to 1.60. The absolute difference in refractive index between the substrate and the first hard coat layer may be, for example, 0.1 or less.

One or both of the first dielectric layer and the second dielectric layer may be, for example, a layer containing a metal oxide different from ITO and IZO, a metal oxide layer containing a metal oxide (excluding ITO and IZO) as a primary component, or a metal oxide layer composed of only a metal oxide (excluding ITO and IZO).

The first dielectric layer may contain, for example, four components: zinc oxide, tin oxide, indium oxide, and titanium oxide or three components: zinc oxide, indium oxide, and titanium oxide as primary components. When the first dielectric layer contains the above four components, the first dielectric layer can have sufficiently high electric conductivity and transparency. The zinc oxide is, for example, ZnO, and the indium oxide is, for example, In₂O₃. The titanium oxide is, for example, TiO₂, and the tin oxide is, for example, SnO₂. The ratio of metal atoms to oxygen atoms in each metallic oxide may be deviated from the stoichiometric ratio.

The “primary component” in the present disclosure means that the ratio with respect to the total is 80% by mass or more. The resistance of the first dielectric layer may be higher resistance than that of the second dielectric layer. Accordingly, the tin oxide content of the first dielectric layer may be lower than that of the second dielectric layer, or may not include tin oxide.

In the case where the first dielectric layer contains three components: zinc oxide, indium oxide, and titanium oxide, when the three components each were converted into ZnO, In₂O₃, and TiO₂, the content of ZnO based on the total of the three components is preferably the highest of the three components. The content of ZnO based on the total of the three components is, for example, 45 mol % or more from the viewpoint of reducing the absorption rate of visible light of the first dielectric layer. In the first dielectric layer, the content of ZnO based on the total of the three components is, for example, 85 mol % or less from the viewpoint of sufficiently enhancing durability under a high-temperature and high-humidity environment.

In the first dielectric layer, the content of In₂O₃ based on the total of the three components is, for example, 35 mol % or less from the viewpoint of reducing the absorptance of visible light of the first dielectric layer. In the first dielectric layer, the content of In₂O₃ based on the total of the three components is, for example, 10 mol % or more from the viewpoint of sufficiently enhancing durability under a high-temperature and high-humidity environment.

In the first dielectric layer, the content of TiO₂ based on the total of the three components is, for example, 20 mol % or less from the viewpoint of reducing the absorptance of visible light of the first dielectric layer. In the first dielectric layer, the content of TiO₂ based on the total of the three components is, for example, 5 mol % or more from the viewpoint of sufficiently enhancing durability under a high-temperature and high-humidity environment. The content of each of the three components is a value determined by converting zinc oxide, indium oxide, and titanium oxide into ZnO, In₂O₃, and TiO₂, respectively.

The second dielectric layer may contain, for example, four components: zinc oxide, indium oxide, titanium oxide, and tin oxide as primary components. The second dielectric layer can have both electric conductivity and high transparency by containing the above four components as primary components. The zinc oxide is, for example, ZnO, and the indium oxide is, for example, In₂O₃. The titanium dioxide is, for example, TiO₂, and the tin oxide is, for example, SnO₂. The ratio of the metallic atoms to the oxygen atoms in the metallic oxides may be deviated from the stoichiometric ratio.

In the second dielectric layer, the content of zinc oxide based on the total of the four components is, for example, 20 mol % or more from the viewpoint of sufficiently increasing the electric conductivity while maintaining high transparency. In the second dielectric layer 22, the content of zinc oxide based on the total of the four components is, for example, 68 mol % or less from the viewpoint of sufficiently enhancing durability under a high-temperature and high-humidity environment.

In the second dielectric layer, the content of indium oxide based on the total of the four components is, for example, 35 mol % or less from the viewpoint of setting the transmissivity within an appropriate range while sufficiently lowering the surface resistance. In the second dielectric layer, the content of indium oxide based on the total of the four components is, for example, 15 mol % or more from the viewpoint of sufficiently enhancing durability under a high-temperature and high-humidity environment.

In the second dielectric layer, the content of titanium dioxide based on the total of the four components is, for example, 20 mol % or less from the viewpoint of ensuring the transmissivity of visible light. In the second dielectric layer, the content of titanium dioxide is based on the total of the four components is, for example, 5 mol % or more from the viewpoint of sufficiently enhancing alkali resistance.

In the second dielectric layer, the content of tin oxide based on the total of the four components is, for example, 40 mol % or less from the viewpoint of ensuring high transparency. In the second dielectric layer, the content of tin oxide based on the total of the four components is, for example, 5 mol % or more from the viewpoint of sufficiently enhancing durability under a high-temperature and high-humidity environment. The contents of each of the four components is a value determined by converting zinc oxide, indium oxide, titanium oxide, and tin oxide into ZnO, In₂O₃, TiO₂, and SnO₂, respectively.

The first dielectric layer and the second dielectric layer combine functions such as adjusting optical properties, protection of the metal layer, and ensuring electric conductivity. The first dielectric layer and the second dielectric layer may contain a trace component or an inevitable component in addition to the components mentioned above to the extent that the functions thereof are not significantly compromised. However, from the viewpoint of obtaining a film heater having sufficiently high characteristics, the proportion of the three components in the first dielectric layer and the proportion of the sum of the four components in the second dielectric layer is preferably higher. Both the proportions are, for example, 95% by mass or more and preferably 97% by mass or more. The first dielectric layer may be a layer consisting of the three components. The second dielectric layer may be a layer consisting of the four components.

The composition of the first dielectric layer may be the same as or different from the composition of the second dielectric layer. When the compositions of the first dielectric layer and the second dielectric layer are identical, it is possible to simplify the production process. The first dielectric layer may be a layer containing four components: zinc oxide, indium oxide, titanium oxide, and tin oxide as primary components, similarly as the second dielectric layer. In this case, the specific proportion of each metal oxide based on the total of the four components in the first dielectric layer may be the same as in the second dielectric layer.

The second dielectric layer is a layer containing the four components as primary components, whereas the first dielectric layer may be a layer containing three components: zinc oxide, indium oxide, and titanium oxide as primary components. This enables the transparency to be kept high and the production cost to be reduced. In this case, the electrical conductivity of the first dielectric layer becomes lower than that of the second dielectric layer, but there is no particular problem because the electric conductivity can be ensured by the second dielectric layer.

The thicknesses of the first dielectric layer and the second dielectric layer are, for example, 3 to 70 nm and preferably 5 to 50 nm, from the viewpoint of achieving both of high transparency and high electric conductivity at a high level. The thicknesses of the first dielectric layer and the second dielectric layer may be the same or different from each other. For example, by individually adjusting the thicknesses of the first dielectric layer and the second dielectric layer, it is possible to prevent changes in the transmissive color tone or to effectively utilize an optical interference effect for converting reflected light to be generated in the metal layer into transmitted light.

The first dielectric layer and the second dielectric layer can be fabricated by a using vacuum film forming method such as a vacuum deposition method, a sputtering method, an ion plating method, or a CVD method. Among these methods, the sputtering method is preferable because a smaller film-forming chamber can be used and the film-forming speed is high. Examples of the sputtering method include DC magnetron sputtering. For the target, an oxide target or a metal or semi-metal target can be used.

The metal layer may contain one or both of silver and silver alloy as a primary component. The total content of silver and silver alloy in the metal layer may be, for example, 90% by mass or more, or 95% by mass or more in terms of silver element. The metal layer may contain a metal (alloy) other than silver and silver alloy. For example, containing at least one element selected from the group consisting of Cu, Ge, Ga, Nd, Pt, Pd, Bi, Sn, and Sb as a constituent element of the silver alloy or a single metal as the metal or the alloy can improve the environmental resistance of the metal layer. Examples of the silver alloy include Ag—Pd, Ag—Cu, Ag—Pd—Cu, Ag—Nd—Cu, Ag—In—Sn, and Ag—Sn—Sb.

The thickness of the metal layer is 5.5 to 7.5 nm from the viewpoint of sufficiently reducing the absorptance of visible light. When the thickness of the metal layer is smaller than this range, the absorption rate of visible light increases, and transparency is impaired. That is, when the thickness of the metal layer is too small, the absorption rate of visible light increases. On the other hand, when the thickness of the metal layer exceeds the above-described range, the absorption rate of visible light becomes high, and transparency is impaired. Therefore, by setting the thickness of the metal layer within the above-described range, the absorption rate of visible light can be sufficiently reduced.

The metal layer can be formed with, for example, DC magnetron sputtering. The film formation method for the metal layer is not particularly limited, and another vacuum film formation method using plasma or ion beam or the like, a coating method using a liquid of constituent components dispersed in an appropriate binder, or the like may be appropriately selected.

The ITO layer or the IZO layer is a layer having higher electrical conductivity than the second dielectric layer. By providing the ITO layer or the IZO layer, it is possible to improve the degree of freedom of material selection of the second dielectric layer. The ITO layer may contain inevitable impurities in addition to ITO. The IZO layer may contain inevitable impurities in addition to IZO. By providing the ITO layer or the IZO layer, the contact resistance can be sufficiently reduced when the electrode is connected to the second dielectric layer side. When the ITO layer or the IZO layer is in direct contact with the second dielectric layer, high transparency can be sufficiently maintained while the film heater is sufficiently thin.

The thickness of the ITO layer (the IZO layer) is, for example, 5 to 40 nm, and preferably 10 to 30 nm from the viewpoint of reducing both the reflectivity and transmissivity of visible light in a balanced manner.

The ITO layer (the IZO layer) can be formed by using, for example, DC magnetron sputtering. The film forming method of the ITO layer (the IZO layer) is not particularly limited, and another vacuum film forming method using plasma or ion beam or the like, a coating method using a liquid of constituent components dispersed in an appropriate binder, or the like may be appropriately selected.

The film heater may have one or more optional layers in addition to those described above. For example, an organic protective layer may be provided on the ITO layer or the IZO layer. The organic protection layer may be a hard coat layer made of, for example, UV curable resins (for example, Z-773L (product name) manufactured by Aica Kogyo Company, Limited) or thermosetting resins. The film heater is suitably used for vehicles, outdoor display devices, and buildings. For example, the film heater may be attached to the surface of a liquid crystal panel to improve the driving property of the liquid crystal. However, the use of the heater-equipped glass is not limited to that described above. The film heater may be adhered on one side of the glass to form a film heater-equipped glass.

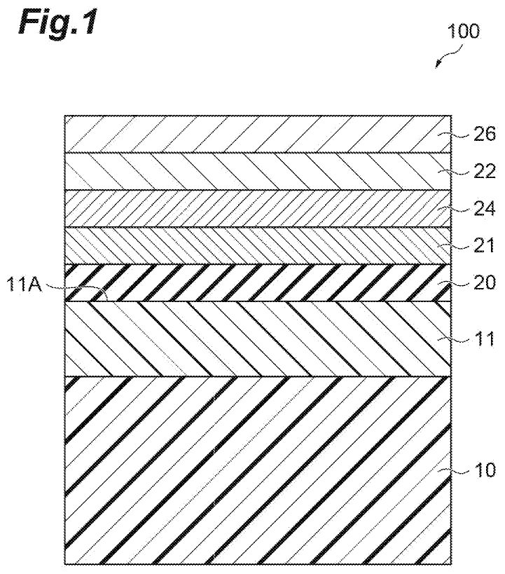

FIG. 1 is a schematic cross-sectional view illustrating an example of a film heater. A film heater 100 of FIG. 1 includes: a substrate 10; a first hard coat layer 11; a high refractive index layer 20; a first dielectric layer 21; a metal layer 24 containing one or both of silver and silver alloy; a second dielectric layer 22; and an ITO layer 26 in the order presented. The substrate 10, the first hard coat layer 11, the first dielectric layer 21, the metal layer 24 containing one or both of silver and silver alloy, the second dielectric layer 22, and ITO layer 26 apply the description above.

The high refractive index layer 20 is a layer that has a higher refractive index than that of the substrate 10, that of the first hard coat layer 11 and that of the first dielectric layer 21. The high refractive index layer 20 may be a layer (third dielectric layer) having a composition different from that of the first dielectric layer 21. By providing the high refractive index layer 20, it is possible to reduce the reflectivity of visible light on the substrate 10 side and improve the flexibility in selecting the material of the first dielectric layer 21. The high refractive index layer 20 may contain, for example, oxides or nitrides, and the refractive index may be 1.8 to 2.5. By providing such a high refractive index layer 20, the reflectivity of visible light on the substrate 10 side can be sufficiently reduced. The high refractive index layer 20 may contain at least one selected from silicon nitride, niobium oxide, and titanium dioxide from the viewpoint of improving the adhesion to the first dielectric layer 21 while sufficiently reducing the reflectivity of visible light on the substrate 10 side.

Preferably, the high refractive index layer 20 contains silicon nitride. Accordingly, the affinity with the silica filler contained in the first hard coat layer 11 is increased. Therefore, the adhesion between the first hard coat layer 11 and the high refractive index layer 20 is increased, and the durability of the film heater can be further improved.

The thickness of the high refractive index layer 20 is, for example, 5 to 40 nm, and preferably 10 to 30 nm, from the viewpoint of reducing both the reflectivity and transmissivity of visible light in a balanced manner.

The high refractive index layer 20 can be formed by DC-magnetron sputtering, for example. The method of forming the film on the high refractive index layer 20 is not particularly limited, and the film may be formed by another vacuum film forming method using plasma, an ion beam, or the like. Such the high refractive index layer 20 has a smooth surface.

In the film heater 100, a peak intensity indicating a Kα line of silicon element detected by fluorescent X-ray analysis of a surface 11A of the first hard coat layer 11 is 15 to 35 cps. The silica filler is sufficiently exposed in such a surface 11A. Accordingly, even if the surface of the layer (the high refractive index layer 20) in contact with the surface 11A of the first hard coat layer 11 is smooth, it is possible to sufficiently maintain the adhesion between the first hard coat layer 11 and the high refractive index layer 20 in direct contact therewith. Therefore, the durability of the film heater 100 can be sufficiently enhanced.

A Part of the ITO layer 26, a part of the second dielectric layer 22, and a part of the metal layer 24 in the film heater 100 may be removed by etching or the like. In this case, the metal layer 24, the second dielectric layer 22, and the ITO layer 26 form a conductor pattern. A part of the first dielectric layer 21 may also be removed by etching or the like.

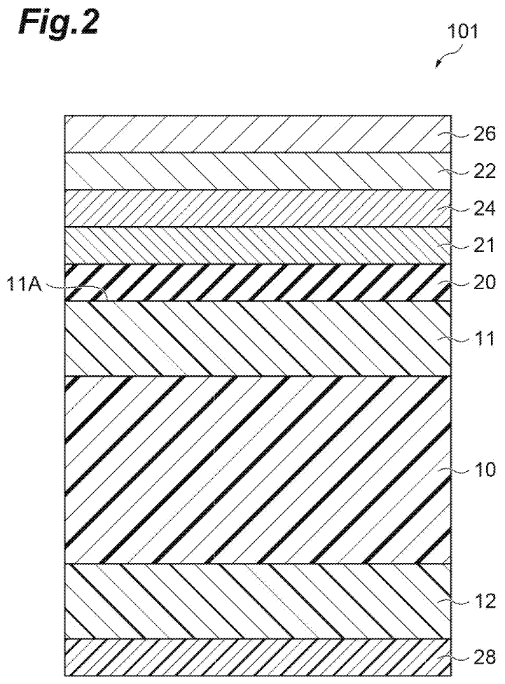

FIG. 2 is a schematic cross-sectional view illustrating another example of the film heater. A film heater 101 of FIG. 2 includes, on one side of the substrate 10, the first hard coat layer 11, the high refractive index layer 20, the first dielectric layer 21, the metal layer 24 containing one or both of silver and silver alloy, the second dielectric layer 22, and the ITO layer 26 in the order presented, similarly to the film heater 100 of FIG. 1. These configurations are the same as those described above.

In addition to the layers described above, the film heater 101 of FIG. 2 further includes, on the other side of the substrate 10, a second hard coat layer 12 and a low reflective layer 28 in the order presented from the substrate 10 side. The second hard coat layer 12 may contain components similar to those of the first hard coat layer 11. For example, the resin composition may contain a resin component (second resin component) obtained by curing a resin composition and a filler dispersed in the resin component. Examples of the second resin component include the same components as those of the first resin component.

The filler contained in the second hard coat layer 12 may be the same silica filler as that of the first hard coat layer 11, or may be a filler different from the silica filler. The content of the filler in the second hard coat layer 12 may be the same as or different from that in the first hard coat layer 11. A filler may not be contained in the second hard coat layer 12. The resin components in the second hard coat layer 12 may be the same as or different from that of the first hard coat layer 11. The second hard coat layer 12 can be formed in a manner similar to the first hard coat layer 11.

The thickness of the second hard coat layer 12 may be, for example, 0.1 to 10 μm, and may be 0.5 to 5 μm. Accordingly, it is possible to sufficiently prevent the occurrence of thickness unevenness, wrinkles, and the like while sufficiently increasing the adhesion between the second hard coat layer 12 and a layer (for example, the low reflective layer 28) that directly contacts the second hard coat layer 12. The refractive index of the second hard coat layer 12 may be, for example, 1.40 to 1.60. The absolute difference in refractive index between the substrate 10 and the second hard coat layer 12 may be, for example, 0.1 or less.

The low reflective layer 28 is a layer having a function of reducing reflection when visible light incident on the film heater 101 from one surface side (ITO layer 26) of the substrate 10 is emitted from the other surface side (low reflective layer 28) of the substrate 10. That is, the low reflective layer 28 forming the surface on the other side of the film heater 101 has a refractive index lower than that of the substrate 10 and that of the second hard coat layer 12 and higher than that of air. Accordingly, the transmissivity of visible light in the film heater 101 can be increased, and even higher transparency can be realized. The refractive index of the low reflective layer 28 may be, for example, 1.1 to 1.4.

The low reflective layer 28 may contain, for example, resin component obtained by curing a resin component and a filler dispersed in the resin component. The filler is preferably hollow. Thereby, the refractive index can be made lower than that of the second hard coat layer 12 and the substrate 10. The filler may be a hollow silica filler. The resin component may include an acrylic-based resin. The thickness of the low reflective layer 28 may be 10 to 300 nm, 30 to 200 nm, or 50 to 150 nm. Accordingly, it is possible to sufficiently prevent reflection while maintaining the thickness of the film heater 101 thin.

The film heater in the present disclosure is not limited to the examples of FIGS. 1 and 2. For example, film heaters 100, 101 may each include any other layer. The film heater 101 may be free of the second hard coat layer 12 and/or the low reflective layer 28. The film heater 100 may include at least one of the second hard coat layer 12 and the low reflective layer 28.

The absorption rate of visible light of the film heaters 100, 101 is, for example, 10.3% or less. Accordingly, the transmittance of visible light can be increased to, for example, 80% or more. The surface resistivity of the ITO layer 26 in the film heaters 100, 101 may be, for example, 5 to 30 Ω/sq. and may be 10 to 20 Ω/sq. Such a film heater is suitably used for vehicular glass (for example, for windshield and rear glass) which is required to have high transparency and excellent defrosting performance and defogging performance.

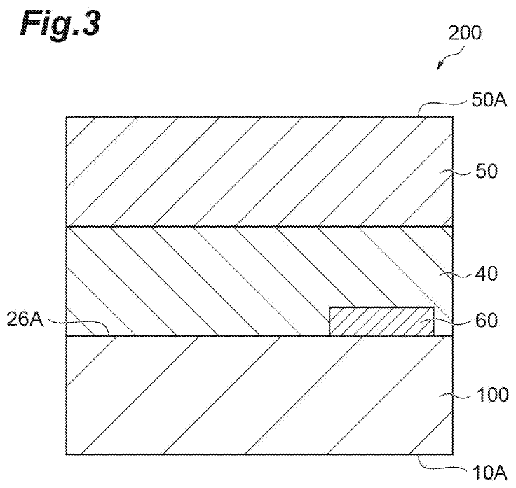

FIG. 3 is a schematic cross-sectional view illustrating an example of a heater-equipped glass. A heater-equipped glass 200 of FIG. 3 includes the film heater 100 of FIG. 1, a glass plate 50 facing a surface 26A on the ITO layer side of the film heater 100, and an adhesive layer 40 between the glass plate 50 and the surface 26A. A part of the surface 26A on the ITO layer side is covered with an electrode 60. The electrode 60 may be formed by applying silver paste to the surface 26A, for example. After the electrode 60 is provided so as to cover a part of the surface 26A of the ITO layer as described above, adhesive is applied so as to cover the surface 26A of the ITO layer and the electrode 60, and the glass plate 50 is disposed so as to face the surface 26A and the electrode 60. Thereafter, the glass plate 50, the surface 26A and the electrode 60 are pressure-bonded in a direction in which they face each other, whereby the heater-equipped glass 200 is obtained. The adhesive forming the adhesive layer 40 may be an optical glue, for example.

The electrode 60 is provided so as to form a pair, and these are connected to a power source (not illustrated) and supplied electricity to cause the film heater 100 to generate heat. Accordingly, ice, frost, and the like sticking on a surface 50A of the glass plate 50 can be removed. In addition, it is possible to smoothly remove water droplets (fog) sticking on a surface 10A of the film heater 100 on the opposite side to the surface 26A on the ITO layer 26 side. The temperature increase (ΔT) of the film heater 100 may be 20 to 45° C. or 25 to 40° C. with respect to the temperature before the temperature increase. Accordingly, it is possible to prevent an excessive temperature increase on the surface 10A while maintaining sufficiently high performance of removing ice, frost, and the like on the surface 50A. From the viewpoint of achieving such a temperature increase, the surface resistivity of the film heater is preferably 5 to 30 Ω/sq., and more preferably 10 to 20 Ω/sq.

In the example of FIG. 3, the heater-equipped glass 200 includes the film heater 100, but is not limited thereto. For example, the film heater 101 of FIG. 2 may be provided instead of the film heater 100, or a modification thereof may be provided.

Although the embodiments of the present disclosure have been described above, the present disclosure is not limited to the above-described embodiments. For example, a modification of the film heater 100 or a modification of the film heater 101 may include an IZO layer instead of the ITO layer 26. In this case, the electrode 60 may be provided so as to cover a part of the surface of the IZO layer to configure a heater-equipped glass.

The present disclosure relates to the following [1] to [5] is included.
[1] A film heater including:
   a substrate;
   a first hard coat layer containing a first resin component and a silica filler;
   a first dielectric layer;
   a metal layer containing one or both of silver and silver alloy;
   a second dielectric layer; and
   an ITO layer or an IZO layer in the order presented,
   wherein a thickness of the metal layer is 5.5 to 7.5 nm, and
   wherein a peak intensity indicating a Kα line of silicon element detected by fluorescent X-ray analysis of a surface on the first dielectric layer side of the first hard coat layer is 15 to 35 cps.
[2] The film heater according to [1], further including:
   a second hard coat layer containing a second resin component; and
   a low reflective layer in the order presented from the substrate side on a side opposite to the first hard coat layer of the substrate,
   wherein the low reflective layer has a refractive index that is less than that of the substrate and that of the second hard coat layer and greater than that of air.
[3] The film heater according to [1] or [2], further including a high refractive index layer between the first hard coat layer and the first dielectric layer.
[4] The film heater according to any one of [1] to [3], wherein a content of the silica filler with respect to the first resin component of the first hard coat layer is 8 to 20% by mass.
[5] A heater-equipped glass, including:
   the film heater according to any one of [1] to [4];
   an electrode on a surface of the ITO layer or the IZO layer; and
   a glass plate facing the ITO layer or the IZO layer and the electrode.

### EXAMPLE

The contents of the present disclosure will be described in more detail with reference to Examples and comparative Examples, but the present disclosure is not limited to the following Examples.

### [Production of Film Heater]

### Example 1

A polyethylene terephthalate (PET) film having a thickness of 125 μm was prepared as a substrate. A first hard coat layer was formed on one surface of the PET film. To be specific, silica filler (average grain size: 100 nm, manufactured by CIK NanoTech, product name: AB-S53), a polymer composition containing an acrylic monomer (curable compound) and a photopolymerization initiator, and a solvent were blended to prepare a coating material. Z-737-9AL (product name) manufactured by Aica Kogyo Company, Limited was used as the acrylic monomer, Irgacure 127 (product name) manufactured by Ciba Specialty Chemicals was used as the photopolymerization initiator, and methyl ethyl ketone was used as the solvent. The content of the photopolymerization initiator based on the mass of the resin composition was 5% by mass. The content of the solvent with respect to the mass of the coating material was 80% by mass. The viscosity) (20° C.) of the coating material was 0.9 mPa.

The coating material was applied to one surface of the PET film, dried, and cured by irradiation with ultraviolet rays to form a first hard coat layer. The content of the silica filler with respect to the resin component in the first hard coat layer, which was calculated from the blending amount of the resin composition (monomer+photopolymerization initiator) in the coating material and the blending amount of the silica filler, was 12% by mass.

A high refractive index layer was formed on the first hard coat layer by DC magnetron sputtering. This high refractive index layer was formed using a boron-doped Si target in a mixed atmosphere containing 80% by volume of argon gas and 20% by volume of nitrogen gas. The high refractive index layer formed in this manner was composed of SiN. The refractive index of the high refractive index layer was 1.9. A first dielectric layer, a metal layer containing silver alloy, a second dielectric layer, and an ITO layer were formed in this order on the high refractive index layer.

The first dielectric layer was formed by using a ZnO—In₂O₃—TiO₂ target, and the second dielectric layer was formed by using a ZnO—In₂O₃—TiO₂—SnO₂ target. The composition (molar ratio) of each target was as shown in Table 1. The first dielectric layer and the second dielectric layer each had the same composition as the target.

The metal layer was formed using an Ag—Pd—Cu target. The composition of the target was Ag:Pd:Cu=99.0:0.5:0.5 (% by mass). The metal layer had the same composition as the target. The ITO layer was formed using an ITO target (In₂O₃—SnO₂ target) in a mixed atmosphere of argon gas and oxygen gas (Ar:O₂=98% by volume: 2% by volume). The composition of the ITO target was In₂O₃:SnO₂=92:8 (% by mass). The ITO layer had approximately the same composition as the ITO target.

In this manner, a film heater including the PET-made substrate, the first hard coat layer, the high refractive index layer, the first dielectric layer, the metal layer, the second dielectric layer, and the ITO layer in this order was obtained. The obtained film heater was cut along the stacking direction using a focused ion beam apparatus (FIB). The cut surface was observed with a transmission electron microscope to determine the thickness of each layer. As a result, the thickness of the first hard coat layer was 1.5 μm, the thickness of the high refractive index layer was 20 nm, the thickness of the first dielectric layer was 10 nm, the thickness of the metal layer was 6 nm, the thickness of the second dielectric layer was 6 nm, and the thickness of the ITO layer was 20 nm.

TABLE 1

| | ZnO | In₂O₃ | TiO₂ | SnO₂ |
|---|---|---|---|---|
| first dielectric layer | 77 | 14 | 9 | 0 |
| second dielectric layer | 35 | 29 | 14 | 22 |

### Examples 2 to 7 and Comparative Examples 1 to 4

A film heater of each Example and each Comparative Example was produced in the same manner as in Example 1 except that the thickness of the metal layer was changed by adjusting the output of the DC-magnetron sputtering and/or the blending amount of the silica filler used in forming the first hard coat layer was changed. In the same manner as in Example 1, the thickness of the metal layer in the film heater and the content of the silica filler in the first hard coat layer in each of Examples and Comparative Examples were obtained. The results are shown in Table 2.

### [Evaluation of Film Heater]

### <Fluorescent X-Ray Analysis>

The ITO layer, the second dielectric layer, the metal layer, the first dielectric layer, and the high refractive index layer of the film heater of each of Examples and Comparative Examples were dissolved and removed by acid-based etching. X-ray fluorescence analysis of the surface of the exposed first hard coat layer was performed. For the measurement, ZSX Primus III (product name) manufactured by Rigaku Corporation was used. The measurement conditions were as follows. From the obtained fluorescent X-ray spectrum, the peak intensity of the Kα line of the Si element was obtained. The results are shown in Table 2.
X-ray tube: Rh 50 kV 50 mA
Spectroscopic crystals: PET
Detector: PC
Measurement diameter: ø30 mm
Measurement atmosphere: vacuum (degree of vacuum: ≤ 10 Pa)
Measurement width and measurement speed: 0.05° steps, 6°/min

### <Measurement of Surface Resistivity>

The film heater of each of Examples and Comparative Examples was cut into a size of length×width=100 mm×100 mm. A pair of electrodes were formed on the surface of the ITO layer of the cut sample using silver paste to obtain a measurement sample. The surface resistivity of the measurement sample (surface resistivity at the surface of the ITO layer) was measured using a four terminal resistivity meter (product name: a loresta EP, manufactured by Mitsubishi Chemical Analytech Co., Ltd.). The results are shown in Table 2.

### <Evaluation of Temperature Increase>

A direct current power source of 12V was connected to the electrode of the measurement sample, and the temperature (T1) after supplying electricity for 10 minutes was measured using an infrared temperature sensor. The temperature increase (ΔT=T1-T0) from the temperature before supplying electricity (T0=25° C.) was determined. The results are shown in Table 2.

### <Measurement of Absorbance of Visible Light>

Using a commercially available spectrophotometer (product name: CM-5, manufactured by Konica Minolta, Inc.), the absorption rate of visible light of the film heater of each of Examples and Comparative Examples was measured. The measurement was performed at intervals of 1 nm in a wave length range of 360 to 740 nm. The average value of the measured values is shown in Table 2 as the light absorptance.

### <Evaluation of Adhesiveness>

The film heater of each of Examples and Comparative Examples was stored for 240 hours in a thermo-hygrostat at a temperature of 85° C. and a relative humidity of 85% RH. Thereafter, the following cross-cut test was performed to evaluate the adhesion between the first hard coat layer and the high refractive index layer. The cross-cut test was performed according to ASTM D 3559-B. To be specific, eleven cuts were made on the surface of the ITO layer at 1 mm intervals along the vertical direction and the horizontal direction, respectively, to form 100 squares of a grid. Thereafter, a cellophane tape was attached to the region where the cut was made. The attached cellophane tape was peeled off, the peeling state in 100 squares was visually confirmed, and the results were classified into six stages of 5B, 4B, 3B, 2B, 1B, and 0B. Between the high refractive index layer and the first hard coat layer, a case where there was no peeling was classified as “5B”, and a case where the ratio of the peeled region was the highest was classified as “0B”. The measurement results are shown in Table 2.

TABLE 2

| | thickness | | peak | | | absorption | |
|---|---|---|---|---|---|---|---|
| | of metal | content | intensity | surface | | rate of | |
| | layer | of filler | of Kα line | resistivity | ΔT | visible light | |
| | [nm] | [mass %] | [cps] | [Ω/sq.] | [° C.] | [%] | adhesion |
| Example 1 | 5.8 | 12 | 19.83 | 21.5 | 25.5 | 9.5 | 4B |
| Example 2 | 6.1 | 12 | 19.83 | 16.6 | 32.5 | 9.8 | 4B |
| Example 3 | 7.3 | 12 | 19.83 | 11.4 | 44.8 | 10.1 | 4B |
| Example 4 | 6.1 | 10 | 17.63 | 16.6 | 32.5 | 9.9 | 4B |
| Example 5 | 6.1 | 12 | 19.83 | 16.6 | 32.5 | 10.1 | 4B |
| Example 6 | 6.1 | 15 | 26.18 | 16.6 | 32.5 | 10.0 | 5B |
| Example 7 | 6.1 | 20 | 33.99 | 16.6 | 32.5 | 10.3 | 5B |
| Comparartive | 4.9 | 12 | 19.83 | 40.6 | 13.9 | 13.8 | 5B |
| Example 1 | | | | | | | |
| Comparartive | 7.8 | 25 | 19.83 | 10.6 | 48.9 | 10.7 | 5B |
| Example 2 | | | | | | | |
| Comparartive | 6.1 | 7 | 13.95 | 16.6 | 32.5 | 10.0 | 0B |
| Example 3 | | | | | | | |
| Comparartive | 6.1 | 25 | 42.17 | 16.6 | 32.5 | 10.8 | 5B |
| Example 4 | | | | | | | |

As shown in Table 2, the absorption rate of visible light of the film heaters of Comparative Example 1 in which the thickness of the metal layer was less than 5.5 nm and Comparative Example 2 in which the thickness of the metal layer was more than 7.5 nm exceeded the target value of 10.3%. In Comparative Example 1, the surface resistivity was high, and ΔT tended to be too small. In Comparative Example 2, the surface resistivity was low and ΔT tended to be too large.

In Comparative Example 3 in which the peak intensity of the Kα line of the silicon element was excessively small, the adhesion between the first hard coat layer and the high refractive index layer was small, and it was confirmed that the durability was insufficient. This is considered to be caused by a decrease in the amount of silica filler exposed to the surface of the first hard coat layer (interface between the first hard coat layer and the high refractive index layer). On the other hand, the absorption rate of visible light in Comparative Example 4 in which the intensity of fluorescent X-rays was excessively high exceeded the target value of 10.3%. This is presumed to be because the content of silica filler was excessive.

On the other hand, in each Example, the absorption rate of visible light was sufficiently small, and the adhesion between the high refractive index layer and the first hard coat layer was also sufficiently excellent. In addition, ΔT was also in an appropriate range, and it was confirmed that the Examples are useful in many applications.

### INDUSTRIAL APPLICABILITY

According to the present disclosure, there is provided a film heater which is excellent in durability and capable of sufficiently reducing the absorption rate of visible light. In addition, there is provided a heater-equipped glass including a film heater which is excellent in durability and capable of sufficiently reducing the absorptance of visible light.

### REFERENCE SIGNS LIST

10: substrate, 10A, 11A, 26A, 50A: surface, 11: first hard coat layer, 12: second hard coat layer, 20: high refractive index layer, 21: first dielectric layer, 22: second dielectric layer, 24: metal layer, 26: ITO layer, 28: low reflective layer, 40: adhesive layer, 50: glass plate, 60: electrode, 100, 101: film heater, 200: heater-equipped glass.

1. A film heater comprising:
a substrate;
a first hard coat layer containing a first resin component and a silica filler;
a first dielectric layer;
a metal layer containing one or both of silver and silver alloy;
a second dielectric layer; and
an ITO layer or an IZO layer in the order presented,
wherein a thickness of the metal layer is 5.5 to 7.5 nm, and
wherein a peak intensity indicating a Kα line of silicon element detected by fluorescent X-ray analysis of a surface on the first dielectric layer side of the first hard coat layer is 15 to 35 cps.

2. The film heater according to claim 1, further comprising:
a second hard coat layer containing a second resin component; and
a low reflective layer in the order presented from the substrate side on a side opposite to the first hard coat layer of the substrate,
wherein the low reflective layer has a refractive index that is less than that of the substrate and that of the second hard coat layer and greater than that of air.

3. The film heater according to claim 1, further comprising a high refractive index layer between the first hard coat layer and the first dielectric layer.

4. The film heater according to claim 1, wherein a content of the silica filler with respect to the first resin component of the first hard coat layer is 8 to 20% by mass.

5. A heater-equipped glass, comprising:
the film heater according to claim 1;
an electrode on a surface of the ITO layer or the IZO layer; and
a glass plate facing the ITO layer or the IZO layer and the electrode.

6. The film heater according to claim 2, further comprising a high refractive index layer between the first hard coat layer and the first dielectric layer.
